(19) United States
(12) Patent Application Publication
(10) Pub. No.: US 2021/0174981 A1
(43) Pub. Date: Jun. 10, 2021

(54) CLEANING COMPOSITION FOR DECONTAMINATING SURFACES, IN PARTICULAR RADIOACTIVE SURFACES, AND RELATIVE DECONTAMINATION

(71) Applicant: WOW NUCLEAR S.R.L., Vigonza (PD) (IT)

(72) Inventor: Adriano Marin, Baone (PD) (IT)

(21) Appl. No.: 17/045,280

(22) PCT Filed: Apr. 10, 2019
(86) PCT No.: PCT/IB2019/052954

§ 371 Date: Oct. 5, 2020

(30) Foreign Application Priority Data
Apr. 13, 2018 (IT) 102018000004473

(51) Int. Cl. G21F 9/00; G21F 9/30

(52) U.S. Cl. CPC G21F 9/004; G21F 9/30

(57) ABSTRACT

The present invention relates to a cleaning composition for the decontamination of surfaces, in particular radioactive surfaces, and the related decontamination method.

The present invention relates to a cleaning composition that is particularly effective in the decontamination of surfaces, in particular radioactive surfaces, and the related decontamination method.

The present invention belongs to the technical field relating to cleaning compositions that can be used and operate very well both in extremely specific fields and in more usual situations.

In fact, there is a strongly felt need to identify cleaning/decontaminating compositions that are biodegradable, do not contain solvents, or surfactants, in large quantities, or acids that react emitting gases that can drag radioactive elements and contaminate by inhalation in the case of nuclear applications, i.e. in the case of cleaning compositions able to clean radioactive material from contaminated surfaces such as, for example, the internal surfaces of a nuclear reactor.

In fact, environmental contamination with radioactive materials is unfortunately a very current problem and common to many countries, which can occur following extraction operations such as, for example, the extraction of uranium, or the effect of contamination due to the use of nuclear plants with inadequate environmental controls, or it may be connected to the disposal of radioactive waste. Alternatively, contamination can occur due to the dispersion of billets of uranium, which have been used as high density material in military or civil applications.

Components or parts of a plant that come into contact with radioactive material are generally contaminated by such material. These parts can include valves, pumps, stirrers, flanges, tube sections, tools and materials including liquid materials which, following contact with radioactive substances, become radioactive. Furthermore, the accumulation of radioactive contaminants increases in the absence of correct decontamination.

Within the context of the environmental problems, a primary objective of any cleaning/decontaminating operation is that of performing the effective cleaning of the material to be cleansed/decontaminated with the production of a minimal quantity of secondary residues to be disposed of and, in the specific case of a radioactive material to be decontaminated, with the production of a minimal quantity of radioactive secondary residues to be disposed of, at minimal costs.

It is known that radioactive elements can be recovered from contaminated materials, by mechanical washing with water, possibly in the presence of appropriate surfactants or detergents. However, such washing procedures are generally limited to the mechanical separation of solid residues and are not able to remove contaminants that are chemically linked to the solid phase, where solid phase means the contaminated material, whether it is steel, cement, soil, etc. Furthermore, the presence of solvents with evaporation drag capacity in these detergents is prohibited, even in small quantities, just as surfactants and very reactive acids that can produce gases able to cause air drag of the radioactive elements themselves are prohibited. Well-known chemical methods exist, which are used for dissolving radioactive contaminants that are insoluble in concentrated solvents such as, for example, treatment with strong acids in a known process such as acid leaching, but these acids are often prohibited or discouraged. In fact, such procedures are effective but they present numerous drawbacks, such as the fact that they also dissolve other contaminants that should not be removed such as, for example, other non-radioactive metals, giving off gases that could be hazardous due to the drag caused by the emission of gases that are not light. Such non-selective dissolution capacity of the metal and the production of gases that lead to dragging make such procedure unsuitable, e.g. for the decontamination of materials such as soil that contains iron and other metals which are not intended to be recovered. Another disadvantage of acidic decontaminating solutions is that materials such as concrete are subject to damage or dissolution in a strongly acidic media. Furthermore, the concentrated solution containing contaminated residues produced during the washing step is a waste that is difficult to dispose of.

Technology has therefore evolved towards different washing solutions that operate through ion exchange procedures with dilute acids or with alkaline substances. Processes of the prior art are often inefficient and require lengthy rinsing procedures for correctly removing the materials or treatment solutions used. In fact, in the removal of radioactive contaminants from surfaces exposed to radioactive emissions, using chemical substances, the exhausted treatment solutions resulting from such decontamination procedures and therefore containing the radioactive contaminants must be in some way removed so as to prevent harmful effects on animals and humans.

The object of the present invention is that of identifying a cleaning composition for removing contaminants, in particular radioactive contaminants from surfaces, parts or equipment exposed to radioactive materials, that overcomes the drawbacks of cleaning compositions according to the state of the art.

Another object of the invention is that of identifying an accurate and efficient washing method that allows the complete and quick removal of contaminants from the treated surface/part.

The subject matter of the present invention is a method for decontaminating from radioactive residuals components or parts of a plant that come into contact with radioactive material, wherein said method comprises applying to said parts an aqueous composition (C) comprising at least:
i. at least one from citric acid, oxalic acid, tartaric acid, malic acid, the respective sodium or potassium salts, ethylenediaminetetraacetic acid (EDTA), preferably in the form of a bisodium salt, other synthetic complexing agents, and mixtures thereof;
ii. at least one solvent selected from methanol, ethanol, ethyl acetate, propanol and isomers thereof, preferably propylene glycol, butanol and isomers thereof, water soluble low molecular weight esters, preferably methyl acetate, ethyl acetate, ethyl formate, dimethyl carbonate, esters of carbonic acid, and mixtures thereof;
iii. optionally at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, preferably lecithin or lysolecithin or coco-glucoside, and relative mixtures to obtain an aqueous mixture comprising the components (C) and residues of the contaminant; and
iv. optionally a possible apolar solvent selected from limonene or another terpene analog thereof, preferably citral, tetrachloroethylene, carbon tetrachloride, other halogenated solvents, and possible mixtures thereof, mixed with said surfactant iii.

The subject matter of the present invention is also a cleaning/decontaminating composition (C) from radioactive residues comprising:
i. at least one selected from citric acid, oxalic acid, tartaric acid, malic acid and the respective sodium or potassium salts (citrates, oxalates, tartrates, malates), ethylenediaminetetraacetic acid (EDTA) preferably in the form of a bisodium salt, and mixtures thereof in amounts from 12 to 45%, preferably from 20 to 35%, by weight with respect to the total weight of the composition;
ii. at least one solvent selected from methanol, ethanol, ethyl acetate, propanol and isomers thereof, preferably propylene glycol, butanol and isomers thereof, water soluble low molecular weight esters, preferably methyl acetate, ethyl acetate, ethyl formate, dimethyl carbonate, esters of carbonic acid and mixtures thereof, in an amount from 1 to 10%, preferably from 2 to 5%, by weight with respect to the total weight of the composition;
iii. optionally, at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, preferably lecithin or lysolecithin or coco-glucoside, and relative mixtures from 1 to 7%, preferably from 2 to 5%, by weight with respect to the total weight of the composition;
iv. optionally, at least one apolar solvent selected from limonene or another terpene analog, preferably citral, tetrachloroethylene, carbon tetrachloride, other halogenated solvents (dissolved in soy lecithin or another suitable emulsifier), and possible mixtures thereof, in an amount from 0.3 to 10%, preferably from 2 to 5% by weight with respect to the total weight of the composition, mixed with said surfactant iii.

Unless otherwise indicated, within the context of the present invention the percentages and quantities of a component in a mixture relate to the weight of such component with respect to the total weight of the mixture.

Unless otherwise specified, within the context of the present invention the indication that a composition “comprises” one or more components or substances means that other components or substances may be present in addition to the one, or ones, specifically indicated.

Unless otherwise specified, within the context of the present invention a range of values indicated for a magnitude, e.g. the content by weight of a component, includes the lower limit and the upper limit of the range. For example, if the content by weight or by volume of a component A is indicated as “from X to Y”, where X and Y are numerical values, A may be X or Y or any one of the intermediate values. Within the context of the present invention, the citric acid can be, indifferently, in anhydrous or hydrated form, e.g. citric acid monohydrate. The amounts relate to anhydrous citric acid, unless otherwise indicated, in the case of using hydrated citric acid, the amounts will consequently be adapted, so as to compensate for differences in molecular mass.

Within the context of the present invention, “decontamination” means the substantial reduction of the radioactivity of a substrate that has come into contact with radioactive material. The measurement of the level of radioactivity can be performed through instrumental methods known to a person skilled in the art, by way of non-limiting example, through the detection of isotopes via Smear test (Bequerel/cm²) followed by Gamma spectrometry (Bq/g) performed through hyperpure Germanium detectors (HPGe) or scintillation detectors (e.g. NaI(Tl)). Within the context of the present invention, the definition “terpene analog of limonene”, includes, without limitations, compounds of natural original, terpenoids or having a monoterpene, diterpene, sesquiterpene structure, which are derivatives, precursors, diastereoisomers, optical isomers of limonene or that comprise in the chemical formula the structure of limonene. Non-limiting examples of said terpenes are cyclic terpene compounds such as terpinene, terpineol, camphor, borneol, menthol, carvone, eucalyptol, bisabolene, bergamotene, carene, carane, pinene, thujene, sabinene, germacrene, valencene, caryophyllene, tujone, extracts and oils such as lemon oil and derivatives thereof, linear terpinene compounds such as: geraniol, citral, myrcene, nerol, neral, citronellol, citronellal, linalool, linalyl acetate, ocimene, farnesol and derivatives thereof, aromatic terpene compounds such as: eugenol, anethole, thymol, safrole, chavicol and derivatives thereof and their isomers, and mixtures thereof.

The composition (C) according to the present invention may contain terpenes, or analogs thereof, in the form of mixtures such as natural citrus extracts or of other plants or matrices of organic origin.

Within the context of the present invention, the definition “natural or synthetic complexing agents” means compounds able to form, reversibly or irreversibly, complexes with heavy metals and/or other contaminants. Non-limiting examples of said complexing agents are, in addition to EDTA and salts thereof, DTPA (diethylenetriamine pentaacetic acid), nitrilotriacetic acid, phosphonates, glycine, polysaccharides, polypeptides, glutamic acid, histidine, polynucleic acids, macrolides, crown ethers, ionophores and mixtures thereof.

In one embodiment, the present invention relates to a method for decontaminating from radioactive residuals components or parts of a plant that come into contact with radioactive material, wherein said method comprises applying to said parts an aqueous composition as indicated above for obtaining an aqueous mixture comprising the components of (C) and residues of the contaminant.

Within the context of the present invention, an isomer of propanol and butanol means at least one alcohol from n-propanol (1-propanol), iso-propanol (or 2-propanol), n-butanol (or 1-butanol), sec-butanol (or 2-butanol), iso-butanol (2-methyl-1-propanol), propylene glycol, dimethyl carbonate, ter-butanol (2-methyl-2-propanol) and mixtures thereof.

In a preferred embodiment, in the method of the present invention the solvent ii. is ethanol, or a mixture of C₁-C₄ alcohols as defined above comprising at least ethanol.

In a preferred embodiment, in the method of the present invention the solvent ii. is dimethyl carbonate, or a mixture comprising at least dimethyl carbonate.

In a preferred embodiment, in the method of the present invention the terpene analog of limonene is at least one from among citral, geraniol, menthol, eucalyptol, lemon oil and citronellol.

Preferably, in the method according to the present invention, in said composition:
the component i. is in a concentration that ranges from 12 to 45%, preferably from 20 to 35%,
the component ii. is in a concentration that ranges from 1 to 6%; and/or
the component iii., if present, is in a concentration that ranges from 2 to 7%
the component iv. is in a concentration that ranges from 0.3 to 10%, preferably from 0.5 to 7.5%, more preferably from 2 to 5%; where the percentages are by weight in relation to the total weight of the composition.

Preferably, in the method according to the present invention, in said composition (C): the acid i. is citric acid and/or the aliphatic alcohol ii. is ethanol, dimethyl carbonate or a mixture thereof and/or, if present, the apolar solvent iv. is limonene, and/or, if present, the surfactant iii. is lecithin or lysolecithin or coco-glucoside, more preferably wherein the acid i. is citric acid, the solvent ii. is ethanol, the possible apolar solvent iv. is limonene, and the possible surfactant iii. is lecithin or lysolecithin or coco-glucoside.

In a preferred embodiment, in the method according to the present invention, in said composition (C) the solvent ii. is dimethyl carbonate and/or, if present, the apolar solvent iv. is a mixture of limonene and citral. The limonene in the composition of the present invention may be, without limitations, racemic limonene (CAS number 138-86-3) or D-limonene (CAS Number 5989-54-8) or any scalemic mixture of the two limonene enantiomers. Preferably, the composition may comprise a mixture of limonene, optionally mixed with citral, and an emulsifier, such as soy lecithin or soy lysolecithin or coco-glucoside.

Preferably, in the composition according to the present invention limonene, where present, is contained in an amount from 0.1 to 5%, more preferably from 1 to 3%, by weight with respect to the total volume of the composition (C), citral, where present, is contained in an amount from 0.2 to 5% by weight with respect to the total volume of the composition (C) and/or coco-glucoside or lecithin or lysolecithin is contained in an amount from 0.1 to 1%, preferably from 0.2 to 0.5% by weight with respect to the total volume of the composition (C).

Preferably, in the method according to the present invention, said composition may further comprise at least one acetic acid, sodium chloride, or mixtures thereof, preferably where the acetic acid is comprised in an amount from 3 to 8% by weight, the sodium chloride is comprised in an amount from 10 to 30% by weight, wherein all the percentages relate to the weight of the component with respect to the total weight of the composition.

Preferably, the method according to the present invention is for the decontamination from radioactive residues of components or parts of a plant that come into contact with radioactive material that are valves, pumps, stirrers, flanges, tube sections or tools.

The subject matter of the present invention is a cleaning/decontaminating composition (C) comprising:
i. at least one selected from citric acid, oxalic acid, tartaric acid, malic acid and the respective sodium or potassium salts (citrates, oxalates, tartrates, malates), ethylenediaminetetraacetic acid (EDTA) preferably in the form of a bisodium salt, and mixtures thereof in amounts from 12 to 45%, preferably from 20 to 35%, more preferably from 25 to 30% by weight with respect to the total weight of the composition;
ii. at least one solvent selected from methanol, ethanol, ethyl acetate, propanol and isomers thereof, preferably propylene glycol, butanol and isomers thereof, water soluble low molecular weight esters, preferably methyl acetate, ethyl acetate, ethyl formate, dimethyl carbonate, esters of carbonic acid and mixtures thereof, in an amount from 1 to 10%, preferably from 2 to 8%, more preferably from 3 to 5%, by weight with respect to the total weight of the composition;
iii. optionally, at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, preferably lecithin or lysolecithin or coco-glucoside, and relative mixtures from 1 to 7%, preferably from 2 to 6%, more preferably from 3 to 5% by weight with respect to the total weight of the composition; and
iv. optionally, at least one apolar solvent, such as limonene or another terpene analog thereof, preferably citral, tetrachloroethylene, carbon tetrachloride, other halogenated solvents, and any mixtures thereof, in amounts from 0.3 to 10%, preferably from 0.5% to 8%, more preferably from 1% to 5%, by weight with respect to the total weight of the composition, mixed with at least one surfactant iii.

In one embodiment, in the composition of the present invention the terpene analog of limonene is at least one from among citral, geraniol, menthol, eucalyptol, lemon oil and citronellol.

In a more preferred embodiment, the composition according to the present invention further comprises at least one from acetic acid and sodium chloride, or mixtures thereof, preferably where the acetic acid is comprised in an amount from 3 to 8% by weight and the sodium chloride is comprised in an amount from 10 to 30% by weight, wherein all the percentages relate to the weight of the component with respect to the total weight of the composition.

The cleaning/decontaminating composition according to the present invention is particularly effective in treating/decontaminating hard surfaces such as, for example, components or parts of a plant that come into contact with radioactive material such as valves, pumps, stirrers, flanges, tube sections, tools or such as pipelines in the oil and gas sector, and more generally in the cleaning/decontamination treatment of various surfaces. The main steps of a first embodiment of the washing/decontamination method from radioactive materials according to the present invention are as follows:
a) positioning of the material to be decontaminated in an appropriate container:

The material, i.e. the part/surface, to be decontaminated, extracted from the plant or from the reactor when necessary, is placed in a suitable container.

The extraction can take place with any known method and system, with suitable lifting and movement means, electric or manual, fixed or movable, which can be dedicated to this specific operation or also have other applications;
b) contact of the material to be decontaminated with a solution containing the cleaning composition according to the present invention:
   the washing takes place in said relevant container where a solution according to claim 1 is inserted, for a time that ranges from 3 to 60 min, at a temperature that ranges from 5 to 40° C.

The washing can be performed through various techniques that possibly also allow the running of the cleaning liquid on the surface to be decontaminated: through the immersion of the surface, through spraying with sprays or pressurized jets, through immersion with prior filling of volumes not affected by the washing through flasks filled with air and waterproof liner compounds resistant to the attack of the detergent.
c) separation of the decontaminated material from the decontamination solution containing the radioactive contaminants to be subject to appropriate subsequent volume reduction and recovery treatments through evaporation processes, or passage on ion exchange resin, or membrane filtering and/or reverse osmosis, etc.

In a second embodiment, the method for washing/decontamination from radioactive materials according to the present invention can be performed through direct treatment with an electropolisher with AC voltage and controlled current, to obtain a galvanic effect that allows an electrochemical activation of the detergent with consequent greater effectiveness, on the part to be treated. To this, a polishing and protective treatment can then be added through oxidation and/or passivation obtained by electrochemical deposition, typically with DC voltage, of an additional passivating agent.

The radioactive materials treated according to the process of the invention can be artificial materials such as concrete or steel, which have been subjected to contamination, or even natural materials, such as soil.

Other characteristics and advantages of the invention will become clear from the following examples provided by way of illustrative and non-limiting example.

### EXAMPLE 1

20 litres of cleaning composition according to the present invention comprising citric acid at the concentration of 20% by weight, ethyl alcohol at the concentration of 1-2% by weight, was tested on a machine of about 40 m³ volume, contaminated by radioactivity.

Through a cleaning treatment with an electropolisher, such composition allowed the removal of all the oxides formed during the operation of said machine located at the SORIN (now Livanova) nuclear waste storage site in Saluggia (Italy) and of all the carbonates, bringing the machine back to a “brilliant” polished state.

During such decontamination process, for each of the radioisotopes mentioned below, the following decontamination factors were reached after every single application with the electropolisher:
¹³⁷Cs>>60, ⁶⁰Co>>400, ²⁴¹Am>>50, ⁹⁰Sr>15, ⁹⁹Tc>20-100

At the end the machine was released, without radioactive prescriptions, as it complied with the following release limits:

| | Smear test | Gamma spectrometry |
|---|---|---|
| 1)Isotope | Limits (Bq/cm²) | Limits (Bq/g) |
| ¹³⁷Cs | 0.37 | 1 |
| ⁶⁰Co | 0.37 | 1 |
| ²⁴¹Am | 0.1 | 1 |
| ⁹⁰Sr | 0.37 | 1 |

and complied with the limit expressed by the following summation

$${\sum }_{i} \frac{Measurement of isotope i Smear test}{Limit of isotope i Smear test} \leq 1$$

1. A method for decontaminating from radioactive residuals components or parts of a plant that come into contact with radioactive material, wherein said method comprises applying to said parts an aqueous composition (C) comprising:
i. at least one of citric acid, oxalic acid, tartaric acid, malic acid and the respective sodium or potassium salts, ethylenediaminetetraacetic acid (EDTA), a bisodium salt, other synthetic complexing agents and mixtures thereof; and
ii. at least one solvent selected from methanol, ethanol, ethyl acetate, propanol and isomers thereof, propylene glycol, butanol and isomers thereof, water soluble low molecular weight esters, methyl acetate, ethyl acetate, ethyl formate, dimethyl carbonate, esters of carbonic acid, and mixtures thereof.

2. The method according to claim 1, wherein said composition (C) further comprises:
iii. at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin and mixtures thereof.

3. The method according to claim 1, wherein said composition (C) further comprises:
iv. at least one apolar solvent, from among limonene or another terpene analog thereof, tetrachloroethylene, carbon tetrachloride, other halogenated solvents, and mixtures thereof.

4. The method according to claim 1, wherein in said composition (C):
the component i. is in a concentration that ranges from 12 to 45%,
the component ii. is in a concentration that ranges from 1 to 6%; or
the component iii. is in a concentration that ranges from 2 to 7%,
the component iv. is in a concentration that ranges from 0.3 to 10%;
where the percentages are by weight in relation to the total weight of the composition.

5. The method according to claim 1, wherein the acid i. is citric acid or the solvent ii. is ethanol or the apolar solvent iv., if present, is limonene, citral or a mixture of limonene and citral, or the surfactant iii., if present, is at least one from coco-glucoside, soy lecithin or lysolecithin, wherein the acid i. is citric acid, the solvent ii. comprises ethanol, dimethyl carbonate or a mixture thereof, the apolar solvent iv., if present, is a mixture of limonene and citral and the surfactant iii., if present, is at least one from among coco-glucoside, soy lecithin or lysolecithin.

6. The method according to claim 1, wherein said composition may further comprise at least one from acetic acid, sodium chloride and mixtures thereof, where the acetic acid is comprised in an amount from 3 to 8% by weight, the sodium chloride is comprised in an amount from 10 to 30% by weight, wherein all the percentages relate to the weight of the component with respect to the total weight of the composition.

7. The method according to claim 1 for the decontamination from radioactive residues of components or parts of a plant that come into contact with radioactive material that are valves, pumps, stirrers, flanges, tube sections or tools.

8. A cleaning/decontaminating composition (C) from radioactive residues comprising:
i. at least one of citric acid, oxalic acid, tartaric acid, malic acid and the respective sodium or potassium salts, ethylenediaminetetraacetic acid (EDTA) a bisodium salt, other synthetic complexing agents and mixtures thereof in amounts from 12 to 45%, by weight with respect to the total weight of the composition; and
ii. at least one solvent selected from methanol, ethanol, ethyl acetate, propanol and isomers thereof, butanol and isomers thereof, and other water soluble low molecular weight esters, preferably methyl acetate, ethyl acetate, ethyl formate, dimethyl carbonate, esters of carbonic acid and mixtures thereof, in an amount from 1 to 10%, by weight with respect to the total weight of the composition;
iii. optionally, at least one surfactant selected from coco-glucoside, alkyl polyglucoside, glyceryl oleate, a linear sodium alkylbenzene sulfonate, sodium lauryl sulfate, sodium lauryl ether sulfate, soy lecithin, soy lysolecithin, and relative mixtures from 1 to 7%, by weight with respect to the total weight of the composition; and
iv. optionally, at least one apolar solvent, such as limonene or another terpene analog thereof, citral, tetrachloroethylene, carbon tetrachloride, other halogenated solvents mixed with at least one surfactant iii, mixed with soy lecithin, soy lysolecithin, and possible mixtures thereof in an amount from 0.3 to 10%, by weight with respect to the total weight of the composition.

9. The composition according to claim 8, further comprising one from acetic acid, sodium chloride and mixtures thereof, where the acetic acid is comprised in an amount from 3 to 8% by weight, the sodium chloride is comprised in an amount from 10 to 30% by weight, wherein all the percentages relate to the weight of the component with respect to the total weight of the composition.
